(19) United States
(12) Patent Application Publication
(10) Pub. No.: US 2015/0139435 A1
(43) Pub. Date: May 21, 2015

(54) ACCOUSTIC MASKING SYSTEM AND METHOD FOR ENABLING HIPAA COMPLIANCE IN TREATMENT SETTING

(71) Applicants: Ben Forrest, Redmond, WA (US); Erik Miller-Klein, Redmond, WA (US)

(72) Inventors: Ben Forrest, Redmond, WA (US); Erik Miller-Klein, Redmond, WA (US)

(21) Appl. No.: 14/543,695

(22) Filed: Nov. 17, 2014

Related U.S. Application Data
(60) Provisional application No. 61/905,276, filed on Nov. 17, 2013.

(51) Int. Cl. G10K 11/178

(52) U.S. Cl. CPC G10K 11/178
USPC 381/73.1

(57) ABSTRACT

A method and system for masking to a listener a conversation between a care provider and a patient such that the conversation becomes unintelligible to the listener, includes interposing an acoustically absorbent curtain that substantially spans between the floor and the ceiling and is positioned between the listener and the care provider and patient. A masking device is affixed to the curtain generally between the floor and the ceiling at a position along the barrier length and at a height approximately coinciding with a height of a mouth of the care provider. The masking device includes at least one speaker having an axis oriented generally perpendicular to the plane the curtain defines. An amplifier drives the speaker to produce a sound to propagate along the axis. A signal source provided at the amplifier input produces the sound selected to mask the conversation between the care provider and the patient.

### FIELD OF THE INVENTION

The invention relates generally to the masking and containment of acoustic energy and specifically to the containment of verbal information.

### BACKGROUND OF THE INVENTION

The Health Insurance Portability and Accountability Act (HIPAA) mandates that individually identifiable patient health information be protected. Although written and computer files are obviously to be protected by means of encryption and suitable network security, nonetheless, verbal information must also be protected. “Covered entities” (those who must comply with the law) must make reasonable efforts to safeguard patient information from being overheard. The law itself gives no specific guidance on how this is to be accomplished, but a document released by the Department of Health and Human Services provides some clarification. It includes, as part of the protection, the phrase “health information whether it is on paper, in computers, or communicated orally”. As a result, many administrators have understood that specific design features ought to be incorporated into design of medical facilities, and in many instances have already begun retrofitting to assure compliance.

The Cone of Silence was one of many recurring joke devices portrayed in “Get Smart,” an American television comedy series of the 1960s about an inept spy. According to the story line, the device is designed to protect the most secret of conversations (aka “C.O.S. security risks”) by enshrouding its users within a transparent sound-proof shield. The fact that the device never works provides fuel for comedy. While the device is fictional, the credibility attached to the gag bears testimony to the difficulty in achieving suitable privacy by simply attenuating the acoustic energy the conversation conveying the private information entails. Damping, by itself, is often inadequate to get the results necessary to achieve compliance with HIPPAA.

Among the best in the simple damping school of privacy protection is the technology disclosed in U.S. Pat. No. 6,446,751 to Ahuja, et al. Comprising acoustical damping material arrayed within a familiar hospital room accessory, the privacy curtain, the product is marketed under the mark “Hush Curtain” and proves to be very effective.

Unfortunately, the redundancy of normal conversation and the remarkable facility of the human brain to reconstruct acoustical speech artifacts into meaningful data means that even the most effective damping strategy may not be enough to achieve the goals of the HIPPAA legislation. To further meet the objectives of the Act, more is often necessary. Rather than to damp energy out of the conversation, augmenting the acoustic energy with random acoustic information is proven to “mask” the conversation.

Sound masking is the addition of natural or artificial sound (such as white noise or pink noise) into an environment to camouflage sound rather than to damp out all acoustic artifacts out of the ambient environment. Additionally, sound masking also reduces or eliminates patient awareness of generated sounds in a hospital area where the work is incident to healing patients. Acoustic levels in today's hospitals are very high. A study conducted by Busch-Vishniac et al. in 2005 found that sound pressure levels have risen significantly and consistently since 1960. Sound masking, thus, has the dual benefits of enhancing privacy and making the environment more conducive for healing.

Sound masking can be explained by an analogy with light. Imagine a dark room where someone is turning a flashlight on and off. The light is very obvious and distracting. Now, imagine that the room lights are turned on. The flashlight is still being turned on and off, but is no longer noticeable because it has been “masked”. Sound masking is a similar process of covering a distracting sound with a more soothing or less intrusive sound. Sound masking is the addition of natural or artificial sound (such as white noise or pink noise) into an environment to cover up unwanted sound. This masking is in contrast to the technique of active noise control which involves elimination of the sound in the selected environment. By contrast, sound masking reduces or eliminates awareness of pre-existing sounds in that environment.

Another challenge renders most masking devices unusable in the hospital environment that of an absolute limitation on the volume of acoustical energy for an acceptable environment for healing. The Facility Guidelines Institute (FGI) has developed a new standard for residential facilities. Titled “Guidelines for Design and Construction of Residential Health, Care, and Support Facilities”, the document provides minimum recommendations for new construction and renovation of nursing homes, hospice facilities, assisted living facilities, independent living settings, adult day care facilities, wellness centers, and outpatient rehabilitation centers. The 2010 FGI/ASHE Guidelines for Design and Construction for Health Care Facilities (“FGI”) allow a 48 dB maximum for noise in the ambient hospital environment. As such, most masking devices are impractical for use in a hospital as they simply spray masking noise into environs in a manner such that to effectively mask conversation, the introduction of over 52 dB by conventional means is necessary to achieve the goal of removing cognizable conversation from the ambient. What is missing in the art is a system for obscuring conversation in a manner to comply with both the requirements of HIPPAA and the FGI.

### BRIEF DESCRIPTION OF THE DRAWINGS

Preferred and alternative examples of the present invention are described in detail below with reference to the following drawings:

FIG. 1 is a block diagram of a curtain and masker system for assuring privacy in conversation within confines the curtain encloses;

FIG. 2 is an acoustic map of a masking output of an inventive masking device affixed to the acoustic curtain to form the curtain and masker system of FIG. 1;

FIGS. 3 and 4 depict a presently preferred embodiment of the invention showing the principal elements as they might be arranged in situ; and

FIG. 5 is Table 3 from the ANSI S3.5-1997 entitled, “Methods for Calculation of the Speech Intelligibility Index.”

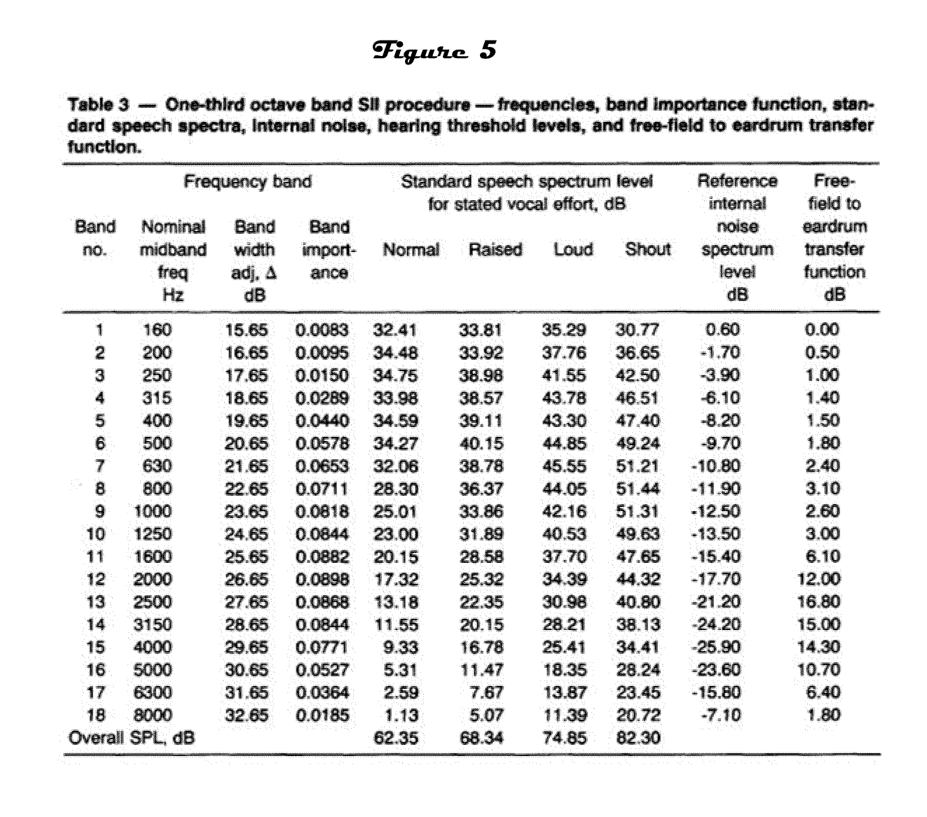

### SUMMARY OF THE INVENTION

A method and system for masking to a listener a conversation between a care provider and a patient such that the conversation becomes unintelligible to the listener, includes interposing an acoustically absorbent curtain that substantially spans between the floor and the ceiling and is positioned between the listener and the care provider and patient. A masking device is affixed to the curtain generally between the floor and the ceiling at a position along the barrier length and at a height approximately coinciding with a height of a mouth of the care provider. The masking device includes at least one speaker having an axis oriented generally perpendicular to the plane the curtain defines. An amplifier drives the speaker to produce a sound to propagate along the axis. A signal source provided at the amplifier input produces the sound selected to mask the conversation between the care provider and the patient.

### DETAILED DESCRIPTION OF THE PREFERRED EMBODIMENT

The U.S. Pat. No. 6,446,751 to Ahuja, et al. entitled “Apparatus and Method for Reducing Noise Levels” (which, by this reference, the inventors fully incorporate herein as though fully reproduced in these pages) provides effective sound damping in hospital and nursing home environments. While having much of the capability to remove acoustic energy from the ambient by providing a flexible sound shielding curtain which contains a plurality of sound insulating sheet inserts encased within pockets or otherwise secured on the exterior surfaces of the panels of a curtain, the damping strategy has proven inadequate for full protection of HIPPA information in conversation. While the Ahuja sound shielding curtain can be tuned to insulate an area from a select range of frequencies inherent in select environments, even at these frequencies, the human brain remains too nimble and capable in reconstructing information therein with what artifacts of speech remain after damping.

To enhance the performance of the Ahuja curtain (known under its commercial name, the “Hush Curtain®”), an extremely specialized masking device relies upon the geometry of the treatment area the Hush Curtain® encloses, the curtain's damping characteristics and a masking device having a tightly configured propagation pattern at specified frequencies, and from a mounting position enabling the masker to inject masking noise as close to the speaker's mouth as possible. In this manner, the propagation of acoustic energy can remain below the 48 dB limit the FGI imposes.

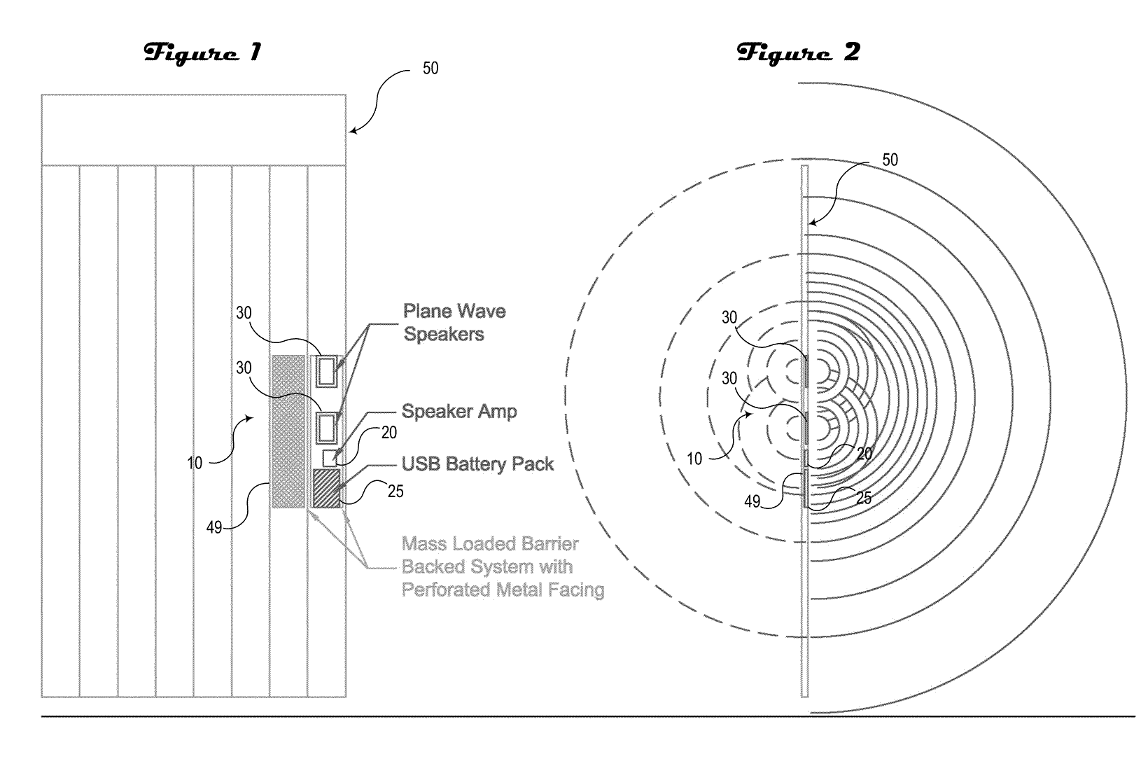

As depicted in FIGS. 1, 2, 3, and 4, the masking device 10 in one embodiment comprises a pink noise generator and amplifier (collectively the “Speaker Amp” 20, having a source of acoustic energy, such as the pink noise generator is integral to the function of the masking device 10; likewise, where rather than a pink noise generator, a signal having programmatic content is used as injected acoustic energy, it is likewise integral to the operation of the masking device 10), the masking device 10 being powered by a power supply, in this non-limiting exemplary case, a battery pack 25 (in a preferred embodiment the battery pack 25 is connected to speaker amp 20 with a conventional USB connecting cord making the device far more durable or, at least, reparable in hospital environs). As is also depicted, in the exemplary embodiment, the speaker amp 20 drives, in this case each of two plane wave speakers 30 to propagate sound energy directly outward.

As FIG. 1 shows, the masking device 10 enjoys a highly effective position affixed as it is shown affixed to the sound damping curtain 50 at a height appropriate to mask conversation at generally the locus of both of the speaker's mouth and the auditor's ears. By placing the speakers 30 in close proximity to the source of the conversation they mask, the device 10 enjoys greater effectiveness with a far more limited power budget than would conventional masking devices which are generally mounted on tables or in ceiling-mounted enclosures.

Just as the device's 10 position (relative to the speaker's mouth) enhances the efficiency of the masking device 10, directionality of the plane wave speakers 30 as are present in a preferred embodiment, yield still greater efficiency gains. The device 10 does not require plane wave speakers but can operate with any form of acoustic driver. Nonetheless, plane wave speakers 30 as are presently preferred for their propagation. Plane wave speakers 30 refer to that class of speaker drivers, distinct from conventional cone-shaped speakers, where sound waves are generated by oscillation of a planar diaphragm in ambient air. Planar magnetic transducers 30 typically consist of two main components: a diaphragm with circuit and magnet arrays 32. The “planar” in planar magnetics refers to the magnetic field that's distributed in the same plane (parallel) to the diaphragm. Planar magnetic diaphragms are thin and lightweight compared to much heavier moving-coil or dome diaphragms found in “dynamic” drivers. This thin diaphragm is suspended in the magnetic fields created by the magnetic arrays 32.

Unlike a dynamic driver with a cone or dome attached to a voice coil, a planar magnetic diaphragm has a printed circuit spread across the surface of a thin-film substrate. When the circuit is energized with an audio signal it interacts with the magnetic field and produces an electromagnetic force that moves the diaphragm back and forth creating sound. For this reason, in the presently preferred embodiment, the propagation pattern and the compact nature of the plane wave speaker 30 is selected in the presently preferred embodiment.

Standard dynamic drivers are fairly small and essentially operate as a point source of sound radiating a spherical section wave front. When a spherical wave front hits propagates through air in a geometrically different way than a planar wave front. The shape of a spherical wave front causes the focusing of sound entering an auditor's ear to behave somewhat differently than would a planar wave front, the spherical wave front lending less perceived definition, thereby allowing the auditor of speech to make out the more defined speech and contrast it to the masking sounds. Therefore, the propagation of a spherical wave front for generated acoustic energy makes the sound propagated far less effective for masking clearly articulated conversation. It is surmised that this disturbance of the reflective characteristics of one's ear may inhibit normal localization of sound, and therefore making it less effective to disturb the audio image heard.

With the characteristic movement of a flat diaphragm a plane wave speaker 30 relies upon to generate sound, the speakers are inherently quite directional, producing the greatest acoustical energy directly in front of the plane wave speakers 10. The characteristic of plane wave speakers is specifically enhanced by the placement of the speakers 10 adjacent, one to another. The planar wave front the plane wave speaker 10 generates is enhanced by wave interference between the two plane wave speakers 30.

In a preferred embodiment, the masking device further includes a volume control for selecting a volume of the masking sound, the volume control selected from the volume control group, the volume control group consisting of a rheostat 21, an electronic volume control responsive to a remote control unit, and a network volume control responsive to a signal received at a network connection the masking device includes. In the simplest embodiment, the rheostat 21 allows the patient to select a suitable volume such that the patient remains comfortable and, in cases where the masking sound is selected to be programmatic material, such as classical music or new age instrumental music, the patient might well wish to select a level of amplification that allows the music to entertain the patient rather than to merely mask conversation. A volume limiter might well be included to assure that the patient may not raise the volume to a level that would distract other patients or care providers within the unit. In further embodiments of the device 10, a remote control such as those commercially available for radio or audio players such as an MP3 player, would allow a patient to adjust the volume without leaving the bed or chair the patient occupies. Still a third option exists wherein the members of the staff might, through networked connection cause the volume to be increased or decreased in accord with some selected criterion such as hospital policy or perceived speech outside of the environment the acoustic curtain encloses.

Wave interference is a phenomenon that occurs when two waves meet while traveling along the same medium, in this case, air. The interference of waves causes the medium to take on a relatively high pressure wave that results from the net effect of the two individual waves upon the particles of the medium. Wave interference can be constructive or destructive in nature. Constructive interference occurs at any location along the medium where the two interfering waves have a displacement in the same direction. For example, if at a given instant in time and location along the medium, the crest of one wave meets the crest of a second wave, they will interfere in such a manner as to produce a “super-crest.” Similarly, the interference of a trough and a trough interfere constructively to produce a “super-trough.” Destructive interference occurs at any location along the medium where the two interfering waves have a displacement in the opposite direction. For example, the interference of a crest with a trough is an example of destructive interference. Destructive interference has the tendency to decrease the resulting amount of displacement of the medium.

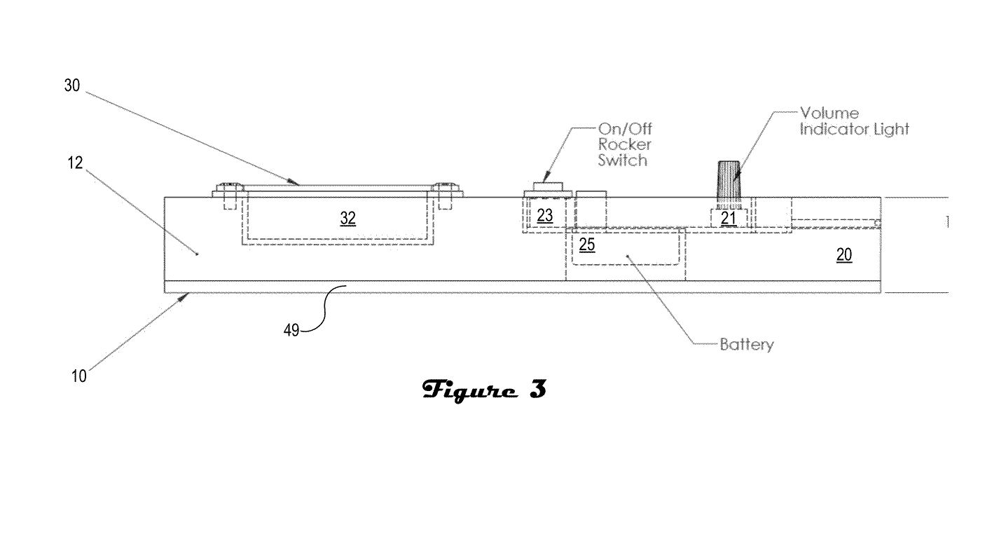

FIG. 2 depicts wave interference as is generated by an embodiment of the invention relying upon two plane wave speakers which are positioned to enhance the planar propagation of waves through the ambient air. The interference of two sets of circular waves with the same frequency and the same amplitude results in a standing wave pattern. These standing wave patterns are known as two-point source interference patterns since they result from the interference of circular waves from two sources. A standing wave pattern is a wave pattern in which there are points along the medium which appear to be standing still. These points are called nodes—points of no displacement. Nodes are produced when destructive interference always occurs at the same location. Both waves have the same magnitude of displacement in opposite directions and interfere to provide complete destructive interference and no resulting displacement of the medium. In a standing wave pattern, the nodes are separated by antinodes. Antinodes are points along the medium which oscillate between a large negative displacement and a large positive displacement. Antinodes result from the constructive interference of two waves. At the antinodal positions, a crest meets a crest to produce a large positive displacement. Moments later, a trough meets a trough to produce a large negative displacement.

A two-point source interference pattern always has an alternating pattern of nodal and antinodal lines. The plane wave speakers 10 are separated by a minimal distance thereby to assure that one antinodal line extends orthogonally forward from the planar surface of the curtain 50 to which they are affixed. As is known, some features of an interference pattern the two plane wave speakers generate can be modified by the distance between the speakers 30. Selecting that distance suitably can assure optimum masking within a frequency range, selected specifically for mid- to high-frequencies within the range of conversational voices.

Given the effective frequencies for masking noise, the nodes of the pattern are oriented along lines—known as nodal lines. Similarly, the anti-nodes in the pattern are also oriented along lines—known as antinodal lines. The spacing between these lines is related to the distance between the plane wave speakers. As the plane wave speakers are moved closer together, the spacing between the nodal lines and the antinodal lines increases. That is, the nodal and antinodal lines spread farther apart as the sources come closer together. The distance between the plane wave speakers is thus chosen so that the nodal lines extend as far off of that orthogonal axis as is practical, thereby yielding a maximum masking effect directly in front of the plane wave speakers.

The interference pattern can be compromised by stray reflected acoustic waves bouncing off of hard surfaces within the immediate vicinity of the patient under treatment. To assure that what energy, the plane wave speakers 30 introduce into the space the curtain 50 encloses, a layer or layers of Mass Loaded Vinyl (MLV) to form a barrier 49 for rearwardly directed acoustic energy thereby attenuating such energy as may, ultimately, be reflected back into the area. MLV is a safe, non-toxic noise barrier designed to hang as a limp mass in a variety of soundproofing applications. The material comprises two principle components: a substrate of vinyl—to give the MLV flexibility (the so-called limpness) and, a naturally occurring, high mass compound embedded in the vinyl. Often Barium Sulfate is used due to its unique properties—it is non-toxic and has a high relative density. This latter attribute, high density, is what makes Mass Loaded Vinyl so effective in blocking sound.

The dissipation of energy as heat within the curtain 50 provides a good absorber, i.e. the “fuzzy stuff” (such as, for example, mineral fiber or fiberglass) for speech energy as distinguished from the acoustic barrier, the MVP represents. Most, if not all, absorbers and barriers have one or both of these characteristics in their design. How these materials are employed in the design of the absorber/barrier or, how and where the absorber/barriers are placed in an environment, is the wizardry of acoustic design. Fuzzy stuff absorbers function by virtue of the fuzzy materials porosity (the percentage of pores or crevices, to the total volume of the mass). These crevices capture the relatively short wavelengths of mid to high-frequency sound and convert the sounds energy to heat via friction.

Blocking sound on the other hand, requires that the material to be used be the opposite in composition to an absorber. The material needs to be dense. Density is derived from mass. Highly dense or massive materials typically do not have a porous structure to allow the sound wave to enter (and pass through) them. Consequently, any material that has a high mass could be used to block a sound's path. Concrete, gypsum board, MDF, hardboard and concrete masonry units are all popular examples of high mass barriers. The problem with using these common building materials as acoustic barriers is that they are very stiff and cannot dissipate energy. They have great mass but they don't get the overall sound reductions you would expect from them because they are not limp and flexible like the Mass Loaded Vinyl (MLV). As is evident in FIG. 2, placement of the MVP barrier assures the acoustic energy emanating out of the rear face of the plane wave speakers 30 does not diffuse the masking effect of the device 10 to optimize the propagation out in front of the plane wave speakers 30.

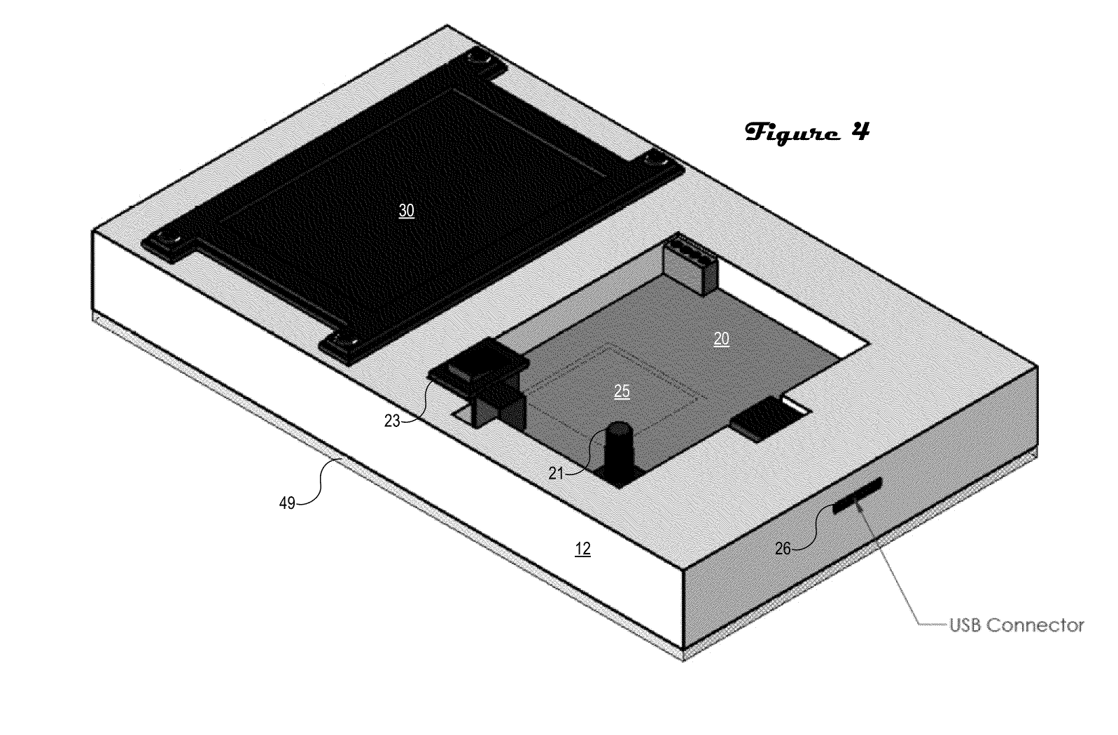

Referring specifically to FIGS. 3 and 4, the plane wave speakers' 30 directional characteristic propagation is enhanced, in one embodiment, with an acoustic foam 12 base; acoustic foam is an open celled foam used for acoustic treatment. It attenuates airborne sound waves by increasing air resistance, thus reducing the amplitude of the waves in the direction perpendicular to a central axis of the plane wave speaker 30. The acoustic energy directed at the base is dissipated as heat as the energy moves foam against its own resilience.

Generally speaking, acoustic foam is employed to improve the sound quality by removing incidental and residual sound energy propagated away from the axis rather than along the axis of the plane wave speakers 30. Given the easy formability of foam made from polyurethane foam, either polyether or polyester, and also fashioned from extruded melamine foam, selective attenuation allows the selective sculpting of the propagation pattern to optimize the masking effect.

Acoustic foam typically absorbs more energy in the mid and high frequencies. Again, sound at these frequencies is the most important for speech recognition, as discrimination of phonemes generally occurs in signals heard in these frequencies. As such, specific interference and damping of sound in those frequencies makes speech discrimination that much more difficult when injecting specific acoustic energy into a defined space to mask that speech. Thus, when suitably propagated, that acoustic energy can be effective in masking even at lower volume propagation.

As described above, the speaker amp 20 driving the plane wave speaker 30 generates sound energy injected into the space adjacent to the patient to mask articulated speech. In one embodiment, “pink noise” is selected for masking rather than the more conventional “white noise.” “White noise” is the term for a very specific type of sound. It has a wide range of frequencies (typically from 20 to 20,000 Hz) generally randomly produced, with equal volume across the entire range. People perceive it as ‘static’ with an uncomfortable, hissing quality very similar to the ‘snow’ broadcast by an untuned television. “Pink noise”, on the other hand, is similar to white noise, but rather than being constant in volume, it decreases at a steady rate as frequency increases (3 dB per octave). Pink noise is less hissy than white noise, but tends to have a rumbling characteristic due the relatively louder low frequency volumes.

To implement the optimal masking, additional natural sounds such as gurgling water sounds or wave sounds augment pure pink noise to serve up an acoustic cocktail to yield further randomness. Sound masking also uses a wide range of randomly generated frequencies, but typically narrower than white noise. Masking signals are usually specified from about 100 to perhaps 6,000 Hz. Also, the volume of these frequencies isn't equal. Rather, they follow a specified, non-linear curve developed for both effectiveness and comfort. Subjectively, sound masking is a far more comfortable sound than white noise and, when properly implemented, tends to fade into the background.

In another embodiment, rather than either of pink or white noise, programmatic material is used. Generally speaking, pink or white noise is optimally generated within the device. In one embodiment, the pink or white noise is recorded in data resident in nonvolatile memory within the device 10 itself and is played back through an MP3 circuit, preferably resident on the chip that includes the amplifier 20. In another embodiment, white noise is created by a white noise generator which mathematically produces a stream of random amplitude impulses over a selected frequency. A random signal is considered “white noise” if it is observed to have a flat spectrum over the range of frequencies that is relevant to the context. For an audio signal, for example, the relevant range is the band of audible sound frequencies, between 20 to 20,000 Hz. Such a signal is heard as a hissing sound, resembling the /sh/ sound in “ash”.

In still another embodiment, non-random sounds have proven efficacious in masking. Programmatic material is any non-random sound and can range in scope or diversity from natural sounds, such as birdsongs or water rushing in a stream, to music, such as orchestral, to distinct speech selected and attenuated to assure that it does not, itself, interrupt the speech it was configured to mask. While such are not as effective as either white or pink noise, patients have shown a far greater tolerance for a volume of programmatic material, than an equivalent volume of white or pink noise.

One example of programmatic material is the content provided by C.A.R.E.™. The premier relaxation programming for patient television, C.A.R.E. (Continuous Ambient Relaxation Environment) is produced to comfort patients, families, and staff in a variety of healthcare settings over the full 24-hour cycle. Programmatic material such as that from C.A.R.E. programming significantly contributes to improved satisfaction and patient outcomes, creating a healing environment for patients, families, and staff. Based on research that connects the use of music and nature to patient outcomes, the C.A.R.E. Channel is appropriate for patients in diverse states of acuity, transcending issues of age, gender, and culture.

The 24-hour format includes unique daytime and nighttime imagery to support the circadian rhythm, enhance sleep, and reduce the negative impact of hospital noise. Combining peaceful scenes of nature video with beautiful music, The C.A.R.E. Channel is a welcome alternative to commercial television and disturbing sounds. Broadcast in more than 750 U.S. healthcare facilities, the C.A.R.E. Channel brings a healing environment to the patient bedside, waiting areas, and public spaces in acute care hospitals, residential care facilities, hospice/palliative care units, cancer centers, children's hospitals, and rehabilitation centers.

Further, in some instances, the presence of sounds recognized as natural, have a calming effect upon the patient under care. Among choices available to either healthcare providers or patients include original, instrumental music that has cross-generational and cross-cultural appeal. It is intentionally selected for its accessibility to a wide-ranging patient population. Additionally, the nature video broadcast on the C.A.R.E. Channel features soothing landscapes, panoramas, and vistas that delight and engage the viewer, evocative of a natural or pastoral setting.

There are two distinct and complementary means of providing this programmatic material to the plane wave speakers, either from a central server either by digital or analog broadcast or from a buffer or memory within the device 10 where programmatic material is stored for recall play back through the plane wave speakers 30. In either embodiment, programmatic material, is fed to an amplifier. In the preferred embodiment, the entirety of the memory, network receiver, signal processor and amplifier are configured in a very large scale integrated circuit (VLSI) configuration. Such a design paradigm, keeps the energy budget lower as there are few capacitive losses across long lines connecting several components. As such, the single heaviest component of the system, the battery 25, can be designed to a smaller specification thereby minimizing the size and weight of the device 10. By the same token, the overall compact size and relatively light weight of the device 10 allows its suspension on the Hush Curtain™ without requiring a separate support structure beyond affixation to the curtain itself.

In an embodiment of the invention, either Wi-Fi, i.e. any of the several IEEE 802.11 specifications for packet wireless communication or Bluetooth™ communication short-wavelength UHF radio waves in the ISM band from 2.4 to 2.485 GHz, are used to receive information to derive the programmatic material. Alternatively, Ethernet or USB wire communication will also support the device 10. In one embodiment, Power over Ethernet or PoE describes any of several standardized or ad-hoc systems which pass electrical power along with data on Ethernet cabling. This configuration allows a single cable to provide both data connection and electrical power to the device 10. Unlike standards such as Universal Serial Bus which also power devices over the data cables, PoE allows long cable lengths. Power may be carried on the same conductors as the data, or it may be carried on dedicated conductors in the same cable. As such, the PoE connection can be sustained from the tracks that suspend the Hush™ Curtain.

Rather extensive research developed the ANSI S3.5-1997 entitled, “Methods for Calculation of the Speech Intelligibility Index.” FIG. 3 depicts Table 3 on page 5 of the ANSI standard and reflects the band importance for masking output. The band importance defines the contribution of speech privacy of each band, and the masking noise is tuned to provide more noise at the more important bands to maximize speech privacy at the lowest overall amplitude. The speaker amp 20 is configured to maximize output in accord with this Table 3 in order to get the greatest masking yield while assuring that it is not necessary to exceed the 48 dB of the FGI. The speaker amp 20 is suitably configured to assure specific production and in a preferred embodiment the amplifier and generator are embodied in solid state configuration.

While the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. A method for masking, to a listener, a conversation between a care provider and a patient such that the conversation becomes unintelligible to the listener, the conversation occurring within a space defined by a floor and a ceiling, the method comprising:
interposing an acoustically absorbent curtain that substantially spans between the floor and the ceiling and is positioned between a treatment group, including the care provider and the patient, and the listener, the acoustically absorbent curtain defining a barrier length;
providing a masking device affixed to the curtain generally between the floor and the ceiling and at a height approximately coinciding with a height of a mouth of the care provider, the masking device including:
at least one speaker having an axis oriented generally perpendicular to the plane the curtain defines; and
an amplifier to drive the speaker to produce a sound to propagate along the axis, the sound being defined according to a signal at an amplifier input; and
providing a masking signal from a signal source to the amplifier input, the masking signal selected to mask the conversation between the care provider and the patient.

2. The method of claim 1 wherein the masking signal is selected from a masking signal group consisting of pink noise, white noise, and programmatic content.

3. The method of claim 2, wherein the programmatic content is selected from among programs selected by The C.A.R.E. Channel for broadcast within a care provider setting.

4. The method of claim 1, wherein the masking device further includes a nonvolatile memory for storage of data and wherein the data stored on the nonvolatile memory is encoded according to an MP3 codec.

5. The method of claim 1, wherein the masking device further includes a network connection data and wherein the data received at the network connection is encoded according to an MP3 codec.

6. The method of claim 1, wherein the masking device includes a power source selected from a power source group consisting of a battery, a power over Ethernet external power source, and an external low voltage power supply.

7. The method of claim 1, wherein the masking device further includes a volume control for selecting a volume of the masking sound, the volume control selected from the volume control group, the volume control group consisting of a rheostat, an electronic volume control responsive to a remote control unit, and a network volume control responsive to a signal received at a network connection the masking device includes.

8. The method of claim 1 further comprising:
providing a mass loaded barrier interposed between the at least one speaker and the acoustically absorbent curtain to impede propagation of sound from the at least one speaker to the acoustically absorbent curtain.

9. The method of claim 1 wherein:
the at least one speaker is a plane wave speaker.

10. A system for masking, to a listener, a conversation between a care provider and a patient such that the conversation becomes unintelligible to the listener, the conversation occurring within a space defined by a floor and a ceiling, the system comprising:
an acoustically absorbent curtain that substantially spans between the floor and the ceiling and is positioned between a treatment group, including the care provider and the patient, and the listener, the acoustically absorbent curtain defining a barrier length;
a masking device affixed to the curtain generally between the floor and the ceiling and at a height approximately coinciding with a height of a mouth of the care provider, the masking device including:
at least one speaker having an axis oriented generally perpendicular to the plane the curtain defines; and
an amplifier to drive the speaker to produce a sound to propagate along the axis, the sound being defined according to a signal at an amplifier input; and
a signal source to feed a masking signal to the amplifier input, the masking signal selected to mask the conversation when the sound between the care provider and the patient.

11. The system of claim 10 wherein the masking signal is selected from a masking signal group consisting of pink noise, white noise, and programmatic content.

12. The system of claim 11, wherein the programmatic content is selected from among programs selected by The C.A.R.E. Channel for broadcast within a care provider setting.

13. The system of claim 10, wherein the masking device further includes a nonvolatile memory for storage of data and wherein the data stored on the nonvolatile memory is encoded according to an MP3 codec.

14. The system of claim 10, wherein the masking device further includes a network connection data and wherein the data received at the network connection is encoded according to an MP3 codec.

15. The system of claim 10, wherein the masking device includes a power source selected from a power source group consisting of a battery, a power over Ethernet external power source, and an external low voltage power supply.

16. The system of claim 10, wherein the masking device further includes a volume control for selecting a volume of the masking sound, the volume control selected from a volume control group, the volume control group consisting of a rheostat, an electronic volume control responsive to a remote control unit, and a network volume control responsive to a signal received at a network connection the masking device includes.

17. The system of claim 10 wherein the device further comprises:
a mass loaded barrier interposed between the at least one speaker and the acoustically absorbent curtain to impede propagation of sound from the at least one speaker to the acoustically absorbent curtain.

18. The system of claim 10 wherein:
the at least one speaker is a plane wave speaker.

19. A system for masking a conversation between a patient and care provider from being heard by persons outside of immediate proximity to the patient and care provider, the system comprising:
an acoustically absorbent curtain substantially spanning the space from a ceiling to a floor and defining in conjunction with any walls, a treatment space; and
a masking device mounted on the acoustically absorbent curtain generally midway between the floor and ceiling at a selected location on the curtain, the masking device including:
a plane wave speaker for propagating sound along an axis perpendicular to a planar face of the plane wave speaker, the plane wave speaker being arranged such that the planar face is generally parallel to the acoustically absorbent curtain;
an amplifier to drive the plane wave speaker producing a masking sound in accord with a masking signal provided to the amplifier at its input; and
a nonvolatile memory and a processor having an MP3 codec for generating a masking signal at the input.

20. The system of claim 19 wherein the device further includes a volume control from the volume control group, a volume control group consisting of a rheostat, an electronic volume control responsive to a remote control unit, and a network volume control responsive to a signal received at a network connection the masking device includes.
